(19) United States
(12) Patent Application Publication
(10) Pub. No.: US 2022/0364309 A1
(43) Pub. Date: Nov. 17, 2022

(54) Device and Method for Self-Improvement via an Edible Affirmation

(71) Applicant: Lisa Noelle Schesser, Scottsdale, AZ (US)

(72) Inventor: Lisa Noelle Schesser, Scottsdale, AZ (US)

(21) Appl. No.: 17/570,149

(22) Filed: Jan. 6, 2022

Related U.S. Application Data
(60) Provisional application No. 63/188,307, filed on May 13, 2021.

(51) Int. Cl. D21H 27/00; A23L 35/00; D21H 11/12; A23L 27/20; D21H 17/28

(52) U.S. Cl. CPC D21H 27/00; A23L 35/00; D21H 11/12; A23L 27/201; D21H 17/28

(57) ABSTRACT

The subject of this invention is embodied in a piece of edible paper that has an affirmation written on it (an “edible affirmation”). This edible affirmation can be used as a tool for self-improvement. In general, an edible affirmation provides a way to partake a word or phrase for the purpose of enhancing the mind, body, and spirit. The user can practice being an expression of the affirmation through focused attention and/or meditation as the edible affirmation dissolves in the mouth and continues for a time thereafter.

### FIELD OF THE INVENTION

The present invention relates to a device and method for self-improvement. More particularly, the device and method relates to an edible slip of paper comprising an affirmation.

### SUMMARY OF INVENTION

The subject of this invention is embodied in a piece of edible paper that has an affirmation written on it (an “edible affirmation”). This edible affirmation can be used as a tool for self-improvement. In general, an edible affirmation provides a way to partake a word or phrase for the purpose of enhancing the mind, body, and spirit. The user can practice being an expression of the affirmation through focused attention and/or meditation as the edible affirmation dissolves in the mouth and for a time thereafter.

The preferred edible affirmation is made from wafer paper. The edible paper is cut into a desired shape and preferably has a tab. The tab allows for the edible affirmation to be easily selected from a box containing a plurality of edible affirmations by allowing the edible affirmation to be picked up with precision. In addition, the tab allows the user to hold and read the edible affirmation without fingers obscuring the words.

It is also preferred to store the edible affirmations in a box comprising a plurality of separate slots. That way a set of affirmations can be placed into the box and selected over the course of time.

### BRIEF DESCRIPTION OF DRAWINGS

FIG. 1 illustrates an embodiment of an edible affirmation comprising a tab on the top right side.

FIG. 2 illustrates an embodiment of an edible affirmation comprising a tab in the center of the top side.

FIG. 3 illustrates an embodiment of an edible affirmation comprising a tab on the top left side.

FIG. 4 illustrates an embodiment of a box comprising a plurality of slots for storing edible affirmations with tabs sticking up for easy and precise selection.

FIG. 5 illustrates an embodiment of a box comprising a plurality of slots for storing edible affirmations with tabs sticking up for easy and precise selection.

### OVERVIEW OF THE PREFERRED EMBODIMENT

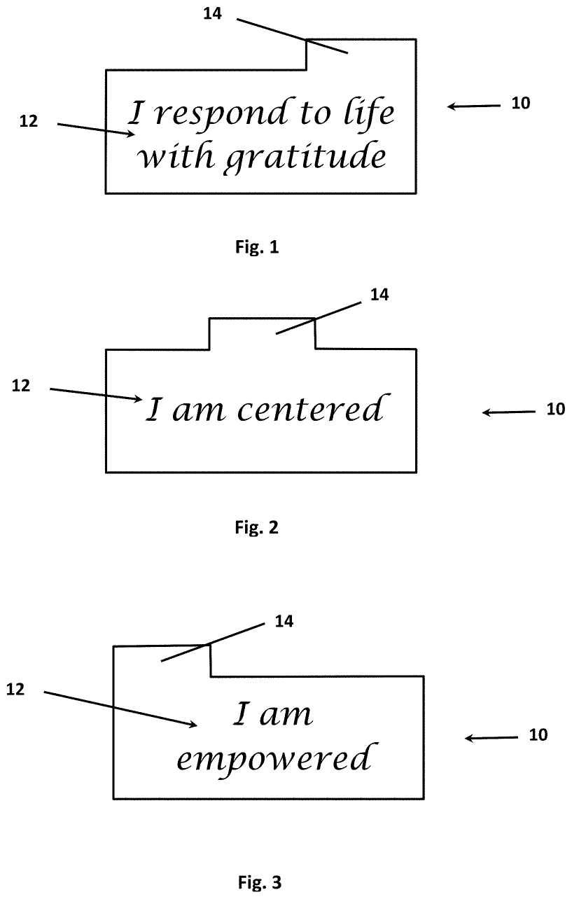

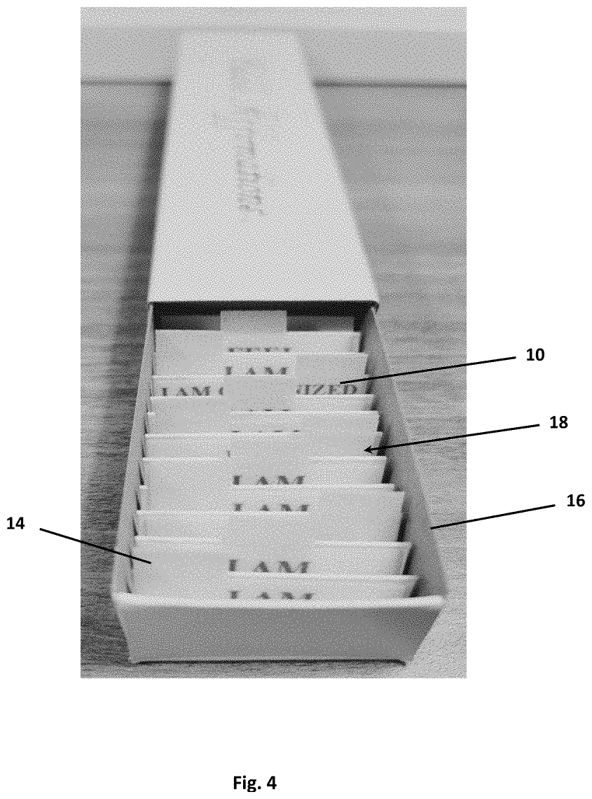

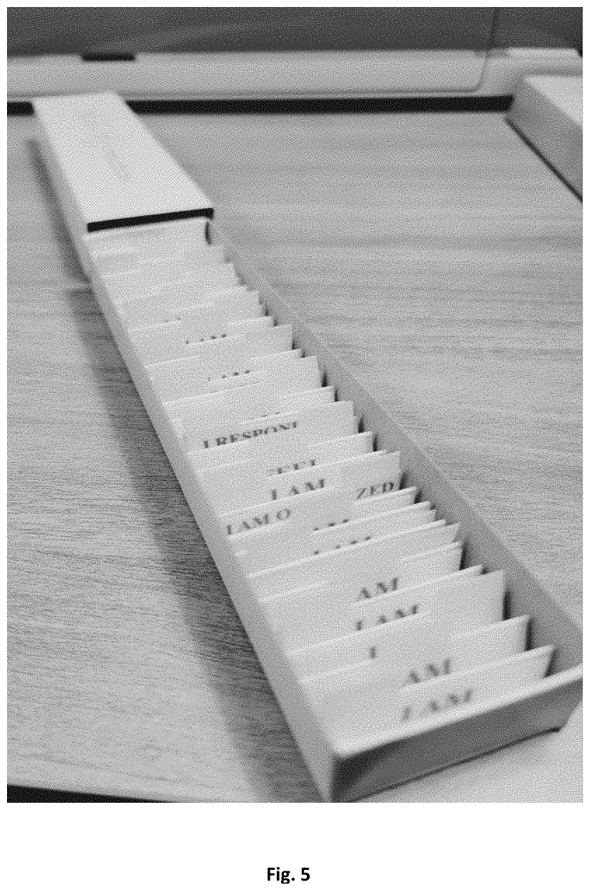

Preferred embodiments of this invention are shown in FIGS. 1-3. FIGS. 1-3 show an edible affirmation 10, which is piece (or section) of edible paper that has an affirmation 12 written on it (referred to in this specification as an “edible affirmation”). The affirmation 12 could be “I respond to life with gratitude,” “I am centered,” “I am empowered,” or any other desired affirmation 12.

The preferred edible affirmation 10 is made from wafer paper (sometimes referred to as rice paper). Other edible paper will work if it can be written on by hand or run through a printer. The preferred ingredients for the non-flavored edible wafer paper (also known as rice paper) include potato starch, water, and vegetable oil, (olive). The preferred ingredients for the vanilla flavored edible wafer paper (also known as rice paper) included potato starch, water, olive oil, sucralose E955, and vanilla flavoring. The preferred vanilla flavored edible wafer paper for this invention is sold under the trademark Icing Images.®

It is preferred to write an affirmation 12 on the paper in edible ink. Most any kind of edible ink will work. One could hand-write the affirmation 12 using a pen or a marker. One could print an affirmation with a printer or one could use a stamp to stamp the affirmation on. It is preferred to use a printer with an edible ink cartridge installed. Many types of suitable edible ink are sold under the trademark “inkedibles.” The preferred edible ink comprises water, propylene glycol, alcohol, fd&c blue 1, red 3, yellow 5, and polysorbate. But most any edible ink known in the art should be suitable.

Most any printer that can use edible ink can be used to print an affirmation 12 on the edible paper. A Model ix6820 from Canon has been found suitable, but most any other printer could work. Likewise, an edible affirmation 10 could be hand-cut from the edible paper. The preferred way to cut an edible affirmation 10 is to use an electronic cutting device like the one sold under the trademark “Cricut Explore.” Other cutting tools, such as a die cutter, would also work.

An edible affirmation 10 can take any shape. The preferred shape used for the base of an edible affirmation is a rectangle with a tab 14 on the top. It is preferred to have three styles: a left tab, a center tab, and a right tab. The preferred shape of an edible affirmation 10, is shown in FIGS. 1-3. The preferred dimensions of an edible affirmation is 1½ inches wide by % inches high (tab height). The preferred non-tab height is 9/16 inch. The preferred way to make an edible affirmation 10 is to use a software program like Microsoft Powerpoint to design the shape, but freehand will work or any guiding aid will work.

The tab 14 allows for the edible affirmation to be easily selected from a box containing a plurality of edible affirmations by allowing the edible affirmation to be picked up with precision. In addition, the tab 14 allows the user to hold and read the edible affirmation without fingers obscuring the words.

It is preferred to make eleven rectangle shapes with a left tab, ten rectangle shapes with a center tab, and ten rectangle shapes with a right tab, totaling thirty one rectangle-tabbed shaped images. Most any number of rectangle shapes with a tab can be made and would work, as long as the tabs can be alternated when placed inside of the edible affirmations box. Within the rectangle shape an affirmation 12 is added to the thirty one images in the form of a word or phrase 12.

The thirty one images with the written affirmations can then be sent to a printer that uses edible ink and edible paper. The printer prints out an edible sheet of paper with thirty one edible affirmations 12 on it. The thirty one images with the written affirmations can then be put through a cutting machine, such as a Cricut machine, where they can be re-sized as needed. The edible affirmations are now arranged in their box and are ready to be packaged and consumed, sold and/or shipped.

It is preferred to store the edible affirmations in a box 16 comprising 31 separate slots 18. That way an entire month of affirmations can be placed into the box and selected over the course of a month. The preferred edible affirmations box 16 contains thirty-one slots 18 that holds one edible affirmation per slot 18, for the potential of a thirty-one day month practice of self-improvement with edible affirmations, by using one edible affirmation 10 per day. Each slot 18 could hold the same affirmation throughout the entire box or there could be a different affirmation in each slot 18, or there could be a grouping of the same affirmations or a grouping of different affirmations in a box.

Alternatively, an edible affirmations box 16 could contain seven slots. That way, a user could populate the seven slots with edible affirmations and utilize the box on a weekly basis. Still, the box 16 could be any box and could contain any number of slots for holding affirmations. A rectangular eco-friendly box with a sleeve is preferred. The box should have at least seven slots and hold at least seven edible affirmations 10.

### Preferred Method of Using an Edible Affirmation

This edible affirmation can be used as a tool for self-improvement. In general, an edible affirmation provides a way to partake a word or phrase for the purpose of enhancing the mind, body, and spirit. The user can practice being an expression of the affirmation through focused attention and/or meditation as the edible affirmation dissolves in the mouth and continuing thereafter, preferably for a minimum of fifteen minutes and a maximum of forty-five minutes.

The preferred method of using an edible affirmation 10 are as follows:
1. Read the edible affirmation 10,
2. Place the edible affirmation 10 on the tongue, and
3. Allow the edible affirmation 10 to dissolve in the mouth as one focuses and/or meditates on being the word or phrase, i.e., the affirmation 12 and preferably continuing between fifteen minutes and forty-five minutes.

It is preferred that the user either read the affirmation out loud or read it silently before putting the edible affirmation in the user's mouth.

It is preferred that before one partakes of an edible affirmation 10 that the person drink water (or other beverage) to wet the tongue and mouth. It is also preferred to not chew or swallow whole the edible affirmation.

The preferred amount of time that one focuses and/or meditates on being the word or phrase is between fifteen and forty-five minutes. For the purpose of this specification, the word “meditation” should be construed broadly to include things like “focusing”, “thinking about”, and “pondering”, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method of self-improvement comprising the steps of:
selecting a piece of edible paper, the piece of edible paper comprising an affirmation,
reading the affirmation,
placing the piece of edible paper into a user's mouth, and
meditating on the affirmation as the edible paper dissolves.

2. The method of self-improvement of claim 1 wherein the piece of edible paper further comprises a tab.

3. The method of claim 1 wherein the piece of edible paper is selected from a box comprising at least seven separate slots.

4. The method of self-improvement of claim 1 wherein the piece of edible paper is selected from a box comprising at least twenty-eight separate slots.

5. The method of claim 1 wherein the meditating step takes between fifteen minutes and forty-five minutes.

6. A method of self-improvement comprising the steps of:
selecting a piece of edible paper, the piece of edible paper comprising an affirmation,
eating the edible paper, and
meditating on the affirmation as the edible paper dissolves.

7. The method of self-improvement of claim 6 wherein the piece of edible paper further comprises a tab.

8. The method of claim 6 wherein the piece of edible paper is selected from a box comprising at least seven separate slots.

9. The method of self-improvement of claim 6 wherein the piece of edible paper is selected from a box comprising at least twenty-eight separate slots.

10. The method of claim 6 wherein the meditating step takes between a minimum a minimum of fifteen minutes and a maximum of forty-five minutes.

11. A device for self-improvement comprising:
a section of edible paper
the section comprising a written affirmation, and
the section comprising a tab.

12. The device of claim 11 further comprising a box with a plurality of slots for storing sections of edible paper.

13. The device of claim 11 wherein the box comprises at least 7 slots.
